(19) United States
(12) Patent Application Publication
(10) Pub. No.: US 2017/0330264 A1
(43) Pub. Date: Nov. 16, 2017

(54) METHODS, APPARATUSES AND SYSTEMS FOR COMPUTER VISION AND DEEP LEARNING

(71) Applicant: YOURO, Inc., Lompoc, CA (US)

(72) Inventors: Mohamed YOUSSEF, Lompoc, CA (US); Amro S. AMER, Lompoc, VA (US)

(21) Appl. No.: 15/587,628

(22) Filed: May 5, 2017

Related U.S. Application Data
(60) Provisional application No. 62/333,954, filed on May 10, 2016.

(51) Int. Cl. G06Q 30/06; G06F 17/30; G06N 3/08; G06F 3/0482

(52) U.S. Cl. CPC G06Q 30/0631; G06N 3/08; G06F 17/3053; G06F 17/3028; G06F 3/0482

(57) ABSTRACT

A system for providing a personalized recommendation of products or services to a user includes at least one user communication device, at least one seller communication device, at least one server configured to communicate with the at least one user communication device and the at least one seller communication device, a memory containing machine readable medium comprising machine executable code having stored thereon instructions for tracking the movements of the at least one object, and a control system comprising at least one processor coupled to the memory, the control system configured to execute the machine executable code to cause the control system to receive at least one image or at least one video pertaining to a products/services from sellers, extract metrics from the at least one image or the at least one video received from the seller, receive at least one image or at least one video from the user, extract metrics from the at least one image or the at least one video received from the user, match the metrics extracted from the at least one image or the at least one video received from the seller with the metrics extracted from the at least one image or the at least one video, rank the product/service based on the match results, and provide recommendation to the user based on the rank.

### FIELD

The present disclosure is directed towards methods and systems for extracting, analyzing and using metrics from images and/or videos received from vendors and customers for recommending products and services.

### BACKGROUND

The following description includes information that may be useful in understanding the present invention. It is not an admission that any of the information provided herein is prior art or relevant to the presently claimed invention, or that any publication specifically or implicitly referenced is prior art.

Currently, customers investigating a specific product, for example, to treat a dermatological malady such as a skin, hear, nail, or other malady have no way of knowing the likely outcomes of using the product. Generally, consumers rely on other friends' recommendations, reviews, or other factors to make purchase decisions. Accordingly, these decisions are based on anecdotal evidence that is not scientifically based or researched, and therefore consumers are unlikely to choose the most beneficial or helpful product based on their own characteristics and environment.

### SUMMARY

### Overview

Accordingly, while consumers investigating products currently rely on the vendor providing before and after photos, the inventor(s) have developed a system that allows personalized customer fit. Particularly, the system allows a customer to take a photo of their own malady (e.g. acne), upload it, and the system to analyze and recommend a product based on the comparison to other user's before and after photos. Accordingly, the system sends a personalized recommendation to the customer based on their own before photo.

In some examples, the inventor(s) developed a system for comparing before and after photos of prior users of certain products to automatically match, score, and rank the best products for a particular user based on a photo of that particular user's malady. For instance, the system may include a server, to which a seller can upload products, upload photos of the prior users before and after pictures related to the products, and upload descriptions or indications for the products.

For each product that is for treating a particular category of malady, (e.g. acne, warts, stains on clothing, etc.) the system may include a database customers that have uploaded before and after photos after using that specific product. Each customer may be associated with specific profile information including the customer's location, ethnicity, skin tone, age, sex, weight, and other features. Accordingly, a machine learning algorithm can be utilized to process the before and after photos of the pictures uploaded, and determine which products had the optimal results, most improvement, or best final result. In some examples the after photos could be ranked by a physician or customer or other human to determine the quality of the outcome for each pair of before and after photos. In other examples, a machine learning algorithm can automatically compare the time elapse after photos to healthy features (e.g. skin with no acne) as the basis for ranking how close the after is to healthy skin.

In other examples, users can upload before and after photos of stains or dirty clothes cleaned by a particular detergent, spot remover, etc. Accordingly, the system may be able to recommend certain products to remove stains after a user photographs a stain, and perhaps categorizes the stain (e.g. wine, etc.). Also, different states or areas may have different water sources, which may have different mineral content, etc. that may work better with certain detergents. Accordingly, one aspect of the product recommendation could be location that could be related to water source.

In other examples, users can upload an image to their face. Accordingly, the system may be able to recommend the best fit sunglass for them based on images provided by sunglasses manufactures. Accordingly, one aspect of the product recommendation could be face measurements, skin color that could be related to person specific face dimension.

Then, once an indication of the performance of each product is determined, average, or otherwise quantified with the customer before and after photos, that information can be saved or analyzed with a machine learning algorithm(s) connected to a database. Then, a user that is searching for a particular product, may have the option to upload their own “before” picture and the server could compare the before pictures from the customer with the user's picture along with other metrics to determine the best match of the before pictures that results in the best outcome.

Accordingly, once the comparison is made, the user could be presented with an array of products and a matching score or a ranking of which product would result in the best outcome for the user. In some examples, the ranking may be based on other factors including adverse reactions (e.g. redness), or other features.

### Machine Vision to Detect Dermatological Defects

Accordingly, in some examples, the system uses a combination of various statistics, artificial intelligence, machine learning, neural networks or other image processing and computer vision algorithms to analyze the before and after photos/videos of prior uses, and recommend a product to a current user. For instance, in some examples, basic neural networks and machine vision may be utilized to (1) identify dermatological maladies on images, (2) compare the before and after photos of prior users, (3) recommend a product to user.

Conventionally, different techniques have been used to detect dermatological defects (such as acne) using different filters on an image of the infected region of a person's body. Some of these techniques have been described in references such as “Biometrics Security: Facial Marks Detection from the Low Quality Images,” International Journal of Computer Applications (0975-8887) Volume 66-No. 8, March 2013, “Device for the identification of Acne, Micromedones, and Bacteria on human skin,” EP0783867, “Learning-Based Detection of Acne-like Regions Using Time-Lapse Features,” by Siddharth K. Madan, Kristin J. Dana and O. Cula, and “Detection of Skin Diseases Using Curvlets,” International Journal of Research in Engineering and Technology Volume: 03 Special Issue: 03.

Accordingly, in some examples, border recognition algorithms may be utilized to identify the acne or other malady on the image of the user's skin, and then certain features of the maladies may be compared once there are identified. In some examples, dimensionality reduction algorithms may be utilized (e.g. Principle Component Analysis, Haar, local binary patterns, histograms of oriented gradients . . . etc.) to first extract a basic set of features for comparison. Then, an algorithm may identify or analyze an image for certain redness or color variations of the appropriate size and geometry. Following, various filters may be utilized to analyze the type of acne (all red, whiteheads, blackheads, etc.) to further determine the product that will be most effective.

Then neural networks or other AI algorithms could be utilized to compare the acne before and after photos of the same users. The algorithms may score the effectiveness by training it first with user ranked improvement. In other examples, the before and after photos may be compared using a ranking of the user of how well it improved. Examples of algorithms that may be utilized include artificial neural networks, Bayesian networks, support vector machines, and other machine learning algorithms.

### Deep Learning for Products/Services Recommendation

However, in some examples, conventional machine learning algorithms that extract features using different filters, (e.g., “bag of visual words” approach, Cascade Object Detector), may not solely be sophisticated enough to analyze small variations in results and comparisons to make recommendations of services to users suffering from dermatological or other issues on different parts of their body.

Accordingly, the present disclosure describes methods, apparatuses and systems using deep learning technology (e.g. convolutional neural networks) for visual recognition and classification to process the images and associated profile data with the images, which outperform the conventional image processing and machine learning algorithms described in the above mentioned references.

According to an aspect of an exemplary embodiment, a system for providing a personalized recommendation of products/services to a user includes at least one user communication device, at least one seller communication device, at least one server configured to communicate with the at least one user communication device and the at least one seller communication device, a memory containing machine readable medium comprising machine executable code having stored thereon instructions for tracking the movements of the at least one object, and a control system comprising at least one processor coupled to the memory, the control system configured to execute the machine executable code to cause the control system to receive at least one image or at least one video pertaining to a product/service from a seller, extract metrics from the at least one image or the at least one video received from the seller, receive at least one image or at least one video from the user, extract metrics from the at least one image or the at least one video received from the user, match or analyze the metrics extracted from the at least one image or the at least one video received from the seller with the metrics extracted from the at least one image or the at least one video, rank the product/service based on the match results, and provide recommendation to the user based on the rank.

According to another exemplary embodiment, the control system is further configured to execute the machine executable code to cause the control system to receive the at least one pre-processed image or the at least one video from the user through a pre-trained deep neural network.

According to another exemplary embodiment, the control system is further configured to execute the machine executable code to cause the control system to receive information regarding location of the user along with the at least one image or the at least one video.

According to another exemplary embodiment, the control system is further configured to execute the machine executable code to cause the control system to rank the product/service based on the received information regarding location of the user.

According to another exemplary embodiment, the control system is further configured to execute the machine executable code to cause the control system to receive at least one of profile information, time of day, age, skin color, ethnicity, medical conditions (e.g. Blood pressure, diabetes . . . etc.), status condition, and gender from the user along with the at least one image or the at least one video. In some examples, the data could be extracted or imported from wearable gadgets or mobile devices such as a mobile phone, a Fitbit, smart watch, etc.

According to another exemplary embodiment, the control system is further configured to execute the machine executable code to cause the control system to rank the product/service based on the received at least one of profile information, time of day, age, skin color, ethnicity, medical conditions (e.g. Blood pressure, diabetes . . . etc.), status condition, and gender. In some examples, the system will interface with a pharmacist, or pharmaceutical database to automatically order the prescription. In other examples, the system will recommend products and direct the customer to potential vendors of the products.

According to another exemplary embodiment, the control system is further configured to execute the machine executable code to cause the control system to store the at least one image or the at least one video pertaining to the product/service received from a seller in a database, and store the at least one image or the at least one video received from the user in the database.

According to another exemplary embodiment, the control system is further configured to execute the machine executable code to cause the control system to partition the database based on one of gender, skin color, age ethnicity, medical conditions (e.g. Blood pressure, diabetes . . . etc.), status condition, and geo-location related current/historic information (e.g. wet/dry, humidity, elevation, UV index . . . etc.).

According to an aspect of another exemplary embodiment, a method for providing a personalized recommendation of products/services to a user includes receiving, using at least one of said at least one processor, at least one image or at least one video pertaining to a product/service from a seller, extracting, using at least one of said at least one processor, metrics from the at least one image or the at least one video received from the seller, receiving, using at least one of said at least one processor, at least one image or at least one video from the user, extracting, using at least one of said at least one processor, metrics from the at least one image or the at least one video received from the user, matching, using at least one of said at least one processor, the metrics extracted from the at least one image or the at least one video received from the seller with the metrics extracted from the at least one image or the at least one video, ranking, using at least one of said at least one processor, the product/service based on the match results, and providing, using at least one of said at least one processor, recommendation to the user based on the rank.

According to another exemplary embodiment, the receiving the at least one image or the at least one video from the user further comprises receiving the at least one image or the at least one video from the user through a pre-trained deep neural network.

According to another exemplary embodiment, the method further includes receiving, using at least one of said at least one processor, information regarding location of the user along with the at least one image or the at least one video.

According to another exemplary embodiment, the method further includes ranking, using at least one of said at least one processor, the product/service based on the received information regarding location of the user.

According to another exemplary embodiment, the method further includes receiving, using at least one of said at least one processor, at least one of profile information, time of day, age, skin color and gender from the user along with the at least one image or the at least one video.

According to another exemplary embodiment, the method further includes ranking, using at least one of said at least one processor, the product/service based on the received at least one of profile information, time of day, location, age, weight, skin color, ethnicity, status condition, health condition, and gender.

According to another exemplary embodiment, the method further includes storing, using at least one of said at least one processor, the at least one image or the at least one video pertaining to the product/service received from a seller in a database and storing, using at least one of said at least one processor, the at least one image or the at least one video received from the user in the database.

According to another exemplary embodiment, the method further includes partitioning the database, using at least one of said at least one processor, based on at least one of gender, skin color, ethnicity, status condition, health condition, age and location information.

According to an aspect of another exemplary embodiment, a system for providing a personalized recommendation of products/services to a user, includes at least one user communication device, at least one seller communication device, at least one server configured to communicate with the at least one user communication device and the at least one seller communication device, a memory containing machine readable medium comprising machine executable code having stored thereon instructions for tracking the movements of the at least one object, and a control system comprising at least one processor coupled to the memory, the control system configured to execute the machine executable code to cause the control system to receive at least one image or at least one video pertaining to a product/service from a seller, store the at least one image or the at least one video pertaining to a product/service received from the seller in a database stored in the memory, refine the databases using a machine learning algorithm and the latest storage in the database, extract metrics from the at least one image or the at least one video received from the seller, receive at least one image or at least one video from the user, store the at least one image or the at least one video received from the user in the database stored in the memory, refine the databases using the machine learning algorithm and the latest storage in the database, extract metrics from the at least one image or the at least one video received from the user, match the metrics extracted from the at least one image or the at least one video received from the seller with the metrics extracted from the at least one image or the at least one video, rank the product/service based on the match results, and provide recommendation to the user based on the rank.

According to another aspect of an exemplary embodiment, a method for providing a personalized recommendation of products/services to a user includes receiving, using at least one of said at least one processor, at least one image or at least one video pertaining to a product/service from a seller, storing, using at least one of said at least one processor, the at least one image or the at least one video pertaining to a product/service received from the seller in a database, refining, using at least one of said at least one processor, the databases using a machine learning algorithm and the latest storage in the database, extracting, using at least one of said at least one processor, metrics from the at least one image or the at least one video received from the seller, receiving, using at least one of said at least one processor, at least one image or at least one video from the user, storing, using at least one of said at least one processor, the at least one image or the at least one video received from the user in the database, refining, using at least one of said at least one processor, the databases using the machine learning algorithm and the latest storage in the database, extracting, using at least one of said at least one processor, metrics from the at least one image or the at least one video received from the user, matching, using at least one of said at least one processor, the metrics extracted from the at least one image or the at least one video received from the seller with the metrics extracted from the at least one image or the at least one video, ranking, using at least one of said at least one processor, the product/service based on the match results, and providing, using at least one of said at least one processor, recommendation to the user based on the rank.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 depicts, in accordance with various embodiments of the present disclosure, a high level view of a system for providing recommendation of service providers to a user based on the user's requirement;

FIG. 2 depicts, in accordance with various embodiments of the present disclosure, a flow chart describing product and image upload from the seller/vendor/service provider and the customer/user interaction with the server;

FIG. 3 depicts, in accordance with various embodiments of the present disclosure, a flow chart describing a process for uploading products and images from the vendor and the customer interaction with the server, where the server is empowered with a machine learning algorithm for processing images from the vendors and customer;

FIG. 4 depicts, in accordance with various embodiments of the present disclosure, a flow chart that describes the process of adding a product review;

FIG. 5 depicts, in accordance with various embodiments of the present disclosure, database partitioning in the memory;

FIG. 6 depicts, in accordance with various embodiments of the present disclosure, a block diagram of an image factory server communicating with an image factory client on a user device and a storage;

FIG. 7 depicts, in accordance with various embodiments of the present disclosure, a block diagram of an image factory server communicating with an image factory client on a user device and an advertising storage.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

The present disclosure is susceptible to various modifications and alternative forms, and some representative embodiments have been shown by way of example in the drawings and will be described in detail herein. It should be understood, however, that the inventive aspects are not limited to the particular forms illustrated in the drawings. Rather, the disclosure is to cover all modifications, equivalents, and alternatives falling within the spirit and scope of the disclosure as defined by the appended claims.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

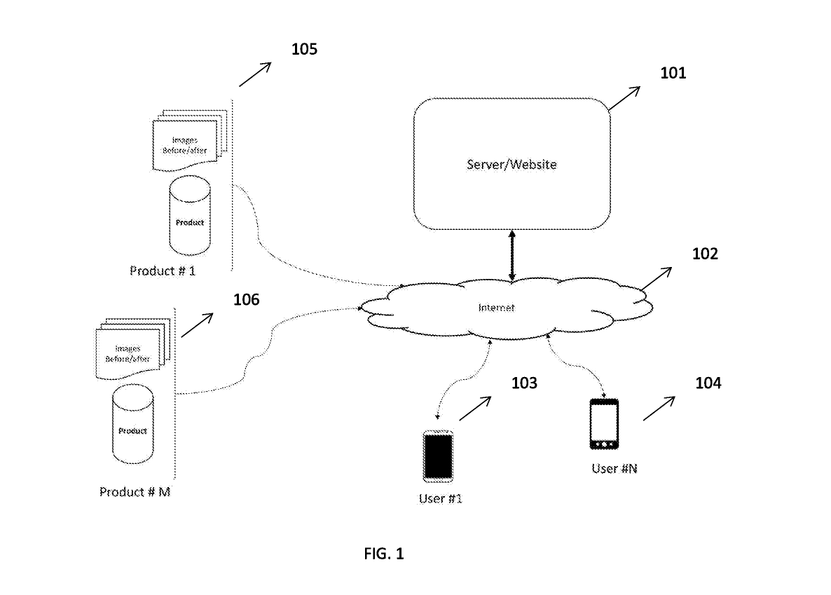

Referring now to the drawings, wherein like reference numerals refer to like features, there is shown in FIG. 1, a high level view of a system for providing recommendation of service providers to a user based on the user's requirement, according to an exemplary embodiment.

### Overview

As can be seen in FIG. 1, a user may use a mobile application using a mobile device 103, 104 to access the internet 102 to look for personalized services for hair, nails, or skin treatment. Accordingly, the user may capture an image on their body of a malady, and upload or send the image or a video of the region (face, arms, hair, nails etc.) for which they would like to find a treatment/product based on their current condition (acne, split ends etc.). Such images are uploaded through the internet 102 to the one or more servers 101 hosting the website and/or mobile application and providing the service.

Once the image and/or video is uploaded, metrics are extracted from the image and/or video. For instance, simple or advanced image processing techniques may extract metrics or features from the images or videos. In some examples, these processing techniques may include machine learning algorithms, or more basic image processing as discussed herein.

Additionally, the user may provide profile information along with the photos that may include (1) the location, (2) age, (3) Camera related information, and (4) other various profile information. Other information may be requested from the user including a category of malady they believe they have (e.g. acne, warts).

Vendors, on the others hand, upload authenticated images before and/or after applying their treatment for specific products 105, 106 along with other metrics (e.g. number of days in treatments “progress”, location related information, gender, age, ethnicity, skin color, medical condition, status condition). For instance, prior users of the products 105, 106 may upload before and after photos. In other examples, the vendors may upload their own before and after photos.

Once these images and/or videos from the vendors are uploaded to the one or more servers 101, the images are processed to extract metrics and features from the images and/or videos along with other relevant information which may be used to rank their products 105, 106 for a particular user. These rankings may be based on analysis of the features extracted from the before and after photos and the metrics extracted from the particular customer's uploaded images/videos, and the customer's profile data. The customer and or vendors may upload multiple images and/or videos according to an exemplary embodiment. Various processing techniques may be utilized to extract metrics or features, including simple image processing algorithms or machine learning algorithms.

Then, various algorithms (e.g. machine learning algorithms) may be employed to rank/recommend the products for the particular user in an order that reflects that will likely result in the best outcome for the user. After the products 105, 106 are ranked, based on a match between metrics extracted from user's image and the metrics extracted for each product, according to another exemplary embodiment, a website may be launched, on the mobile devices 103, 104 of the customer. The website may include information relating to the respective treatment being sought after by the customer, and may display the top products/services available from different vendors for treatment.

The use of mobile devices by the user is merely exemplary and the user may upload the images using a computer connected to the Internet or other means. In addition to uploading images, the vendors may upload information regarding previous customers who received the treatment, and such information may be used in ranking the products/services offered. According to an exemplary embodiment, age of a previous customer whose photos are uploaded by the vendor/seller may be compared with the age of the match between metrics extracted from user's image and the metrics extracted for each product current customer looking for personalized recommendation in determining the rank of the product. Thus, the lesser the age gap, the more appropriate the product will be, in turn leading to a higher ranking. Numerous other parameters may be used while ranking the available products/services.

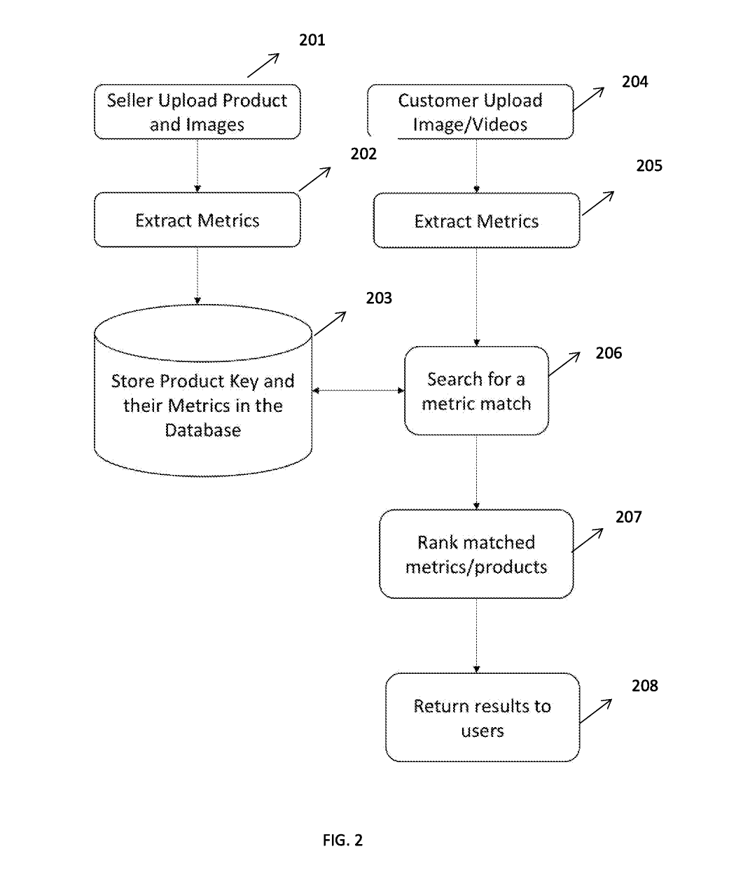

FIG. 2 depicts, in accordance with various embodiments of the present disclosure, a flow chart describing product and image upload from the vendor and the customer interaction with the server. As shown in FIG. 2, vendors may upload specific products, and images associated with those products that may comprise before and after photos. The vendor may indicate or select a category of products (e.g. acne medication) to which its product applies. In some examples, a vendor may log onto a website for uploading its products, and the website may display options for categories of products that may be uploaded, including wart removers, acne medications, etc. Then, the vendor may upload various before and after photos associated with particular users, and provide profile information for those users. In other embodiments, various prior users may upload before and after photos associated with a particular vendor, which may be stored for later usage.

In step 202, the servers 101 process the uploaded images and extract metrics from the images/videos which are later used for comparison and ranking purposes. For instance, the server 101 may first process the uploaded images to reduce the dimensionality by using Principle Component Analysis, Discriminate Analysis, Multivariate Analysis, Blob Detection, Color Segmentation, Markov Random Field or other dimensionality reduction to process the images. In some examples, the uploaded images will contain a category of malady designated by the user, so the server 101 can run a different version of an algorithm designed for the particular malady. In other examples, the servers 101 may use a classifier to classify the malady in a picture uploaded by a user (e.g. support vector machine, neural networks, nearest neighbors, bagging).

For instance, if the user uploaded before and after pictures of acne, the system may first run a border recognition algorithm that would like for the borders of acne like redness (for example). Then, the system may be trained to look for certain features of the acne. For instance, the system may look for white or black spots, size of acne, amount of acne, color gradient etc. The system may use certain filters, or other algorithms for recognition and quantification of the features.

In other examples, the user may upload a before and after picture of a stain, the system may first run a border recognition algorithm that would look for color threshold changes perhaps of irregular shape to identify the stain. Then, the system may be trained to look for certain features of the stain. For instance, the system may look for different colors, saturations, sizes, color gradients, etc.

The servers may also extract other information in step 202 which relate to the personal profile of the prior users as well as the geographic location of the users associated with the uploaded images. For instance, the uploaded images may include the age, sex, weight, medical history or other relevant information that may be associated with the photos.

In step 203, the product information and the metrics are stored in the database. For instance, each product category (e.g. acne medication) may include various products 105, 106, with several instances of prior users, their before and after photos, and their profile information. In some examples, each instance may be automatically or manually ranked for the optimal outcome relative to the starting condition (e.g. the severity of the starting condition). Then, in some examples, this data may be fed as training data into a deep learning or other machine learning algorithm to train the computer to determine the features (e.g. features from the image or profile data) that a particular product may be best suited for. For instance, certain acne medications may be best for white heads, others for heavily red and prevalent acne, others for wine stains, dirt stains, grass stains, etc. In some examples, the deep learning algorithm may be a surpervised learning algorithm, unsupervised learning, semi-supervised learning, algorithm and the training sets may be utilized accordingly.

A customer who is looking for personalized recommendation for treatment of a particular region on his/her body for a particular malady may also upload images/videos to the servers in step 204. For instance, the customer may indicate a category of malady that the customer would like to treat (e.g. acne, warts), provide their profile information through an interface, and then upload their videos to the server 101. The servers 101 may further request profile information from the customer in step 204 such as geographical information of the customer, time of day, age and other profile information.

In step 205, the servers extract metrics and other information from the images/videos uploaded by the customer—in a similar manner to that of the vendor photos or prior users. However, in this case, the photo uploaded by the customer is only the “before” photo because the customer has not yet treated their condition. The servers may process the before images using an algorithm specialized to detect and analyze the malady indicated by the customer while uploading the photo. For instance, if the user indicates they have acne in the photo, a border detection and classification algorithm may be run to identify the acne, and perhaps identify features most relevant to product selection and outcomes as determined by the before and after photos uploaded by the vendors. In other example a machine learning algorithm such as a deep learning neural network may be used to process the images.

In step 206, the server may process the before photos to identify matching products that are most likely to provide the best outcome to the user by matching the metrics extracted from the customer images/videos and the metrics of different products and services stored in the database. For instance, a pre-trained deep learning neural network may process the before photo, and determine which of the products will provide the best outcome. In some examples, the deep learning neural network may be consisting of a multiple hidden layer neural network architecture.

Once the search is conducted, the products/services whose extracted metrics match the metrics of the customer images/videos are ranked based on the score of the match and other extracted information in step 207. The other information which may affect the ranking of the matched products/services may include geographical proximity to the customer, information of past customers who have used the product/service in questions etc. but is not limited thereto.

Once the ranking is complete, the final ranked results are returned to the customer in step 208. For instance, the server 101 may send the ranking the customer's mobile device. The ranking may then be displayed using a network browser, local application, or other implementation.

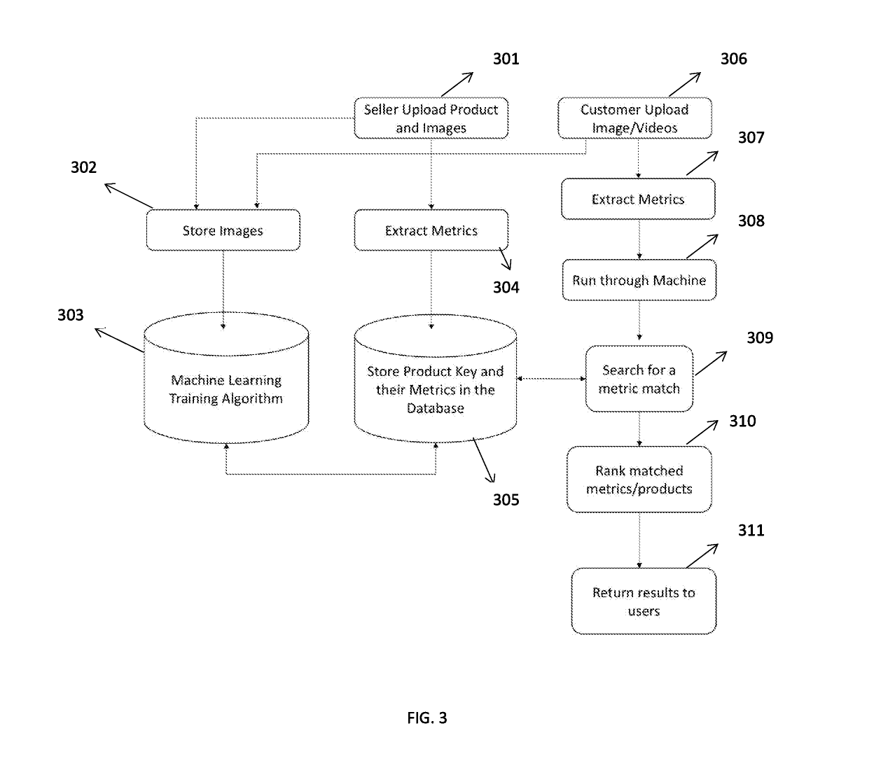

FIG. 3 depicts, in accordance with various embodiments of the present disclosure, a flow chart illustrating a method for uploading and processing products and images uploaded from the vendor and seller using machine learning algorithms. As shown in FIG. 3, vendors may upload images and/or videos to the servers in step 301. The images/videos may be before and after photos of treatments of past users using their products or services.

In step 302, the images/videos uploaded by the vendors are stored and may be used further used as training data to train a machine learning algorithm running on the servers in step 303. For instance, the before and after photos may be analyzed to evaluate outcomes, may be ranked by users or vendors, or may be ranked by the owner of the server. Then, the machine learning algorithm could be trained using the profile data, the before and after photos, and indications of outcomes (in some examples), to develop on algorithm that can predict outcomes based on profile data and a before photo. In some examples, predicting outcomes will actually be ranking available products based on the customer profile data and the customer before picture.

The images/videos uploaded by the customers in step 306 (discussed below) are also stored for the purpose of training the machine learning algorithm in step 302 and each customer that uploads a before photo for purposes of product recommendation, may also upload and after photo to be used to further train the machine learning algorithms to make recommendations for future users. The machine learning algorithm used may be a neural network or a support vector machine, according to an exemplary embodiment, but is not limited thereto.

In step 304, the servers process the images and extract metrics from the images/videos which are later used for comparison and ranking purposes. The method of extracting and comparing metrics will be discussed below in greater detail. The servers may also extract other information in step 304 which relate to the personal profile of the customer as well as the geographic location of the user. For instance, Principal Component Analysis, border recognition algorithms, filters or other image processing techniques may be applied to extract features known to be relevant to product selection for outcomes, or to evaluate outcomes.

In step 305, the product information and the metrics are stored in the database. For instance, the database may store 305 each of the products uploaded by the vendor referenced to a product key identifying the particular product of the particular vendor, the vendor, the category of products to which it will be compared, and the data extracted from the images.

A customer who is looking for personalized recommendation for treatment of a particular region on his/her body uploads images/videos to the servers in step 306. As discussed above, the images/videos uploaded by the customer are stored in step 302 and are optionally used to train the servers using the machine learning algorithm in step 303.

In step 307, the servers process the images and extract metrics and other information from the images/videos uploaded by the customer. The servers may further extract other relevant information in step 307 such as geographical information of the customer, time of day, age and other profile information. In step 308, the extracted metrics are processed by the machine learning algorithm or other algorithm that is running on the servers. In step 309, the algorithm or different algorithms identify and rank matches based on the customer request for a product category and the metrics extracted from the customer images/videos and the metrics of different products and services stored in the database and the customer's profile data.

Once the matching search is conducted, the products/services whose extracted metrics match the metrics of the customer images/videos are ranked based on the score of the match and other extracted information in step 310. The other information which may affect the ranking of the matched products/services may include geographical proximity to the customer, information of past customers who have used the product/service in questions etc. but is not limited thereto. Once the ranking is complete, the final ranked results are returned to the customer in step 311.

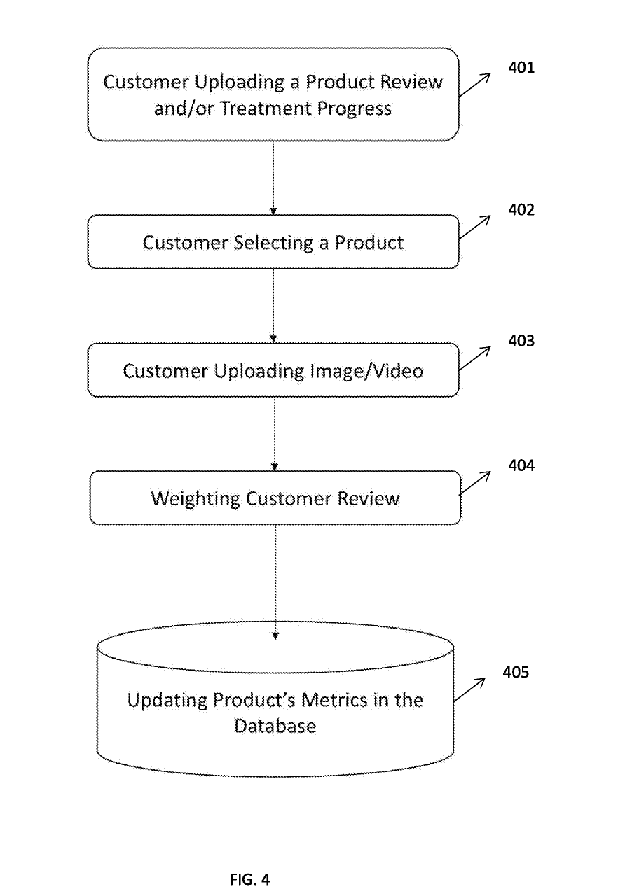

FIG. 4 depicts, in accordance with various embodiments of the present disclosure, a flow chart that describes the process of adding a product review, according to an exemplary embodiment. Accordingly, another parameter that may be used for matching and/or scoring/ranking the different products/services may be customer reviews. For instance, the outcome determinations made for the before and after photos for prior customers may be weighted based on the customer reviews or ranking. In some examples, the outcome determinations may be made solely based on customer reviews.

As shown in FIG. 4, a customer uploads a product/service review and/or a description of the progress of a treatment received by a vendor in step 401. Following the review, the customer selects a product/service the review applies to in step 402. The customer further uploads images/videos related to that product usage on the relevant region on the body in step 403. The images/videos may depict the results of the product/service providing a picture of the region of the body in question.

The customer review is then weighted based on different factors in step 404. The weighting of the customer review may depend on numerous factors such as the reputation of the customer on the website, the age of the customer, the geographic location information etc. but are not limited thereto.

In step 405, the product's/service's metric which were stored in the database are updated based on the weighted customer review. In this manner, the ranking of the product/service may be affected based on reviews uploaded by customers.

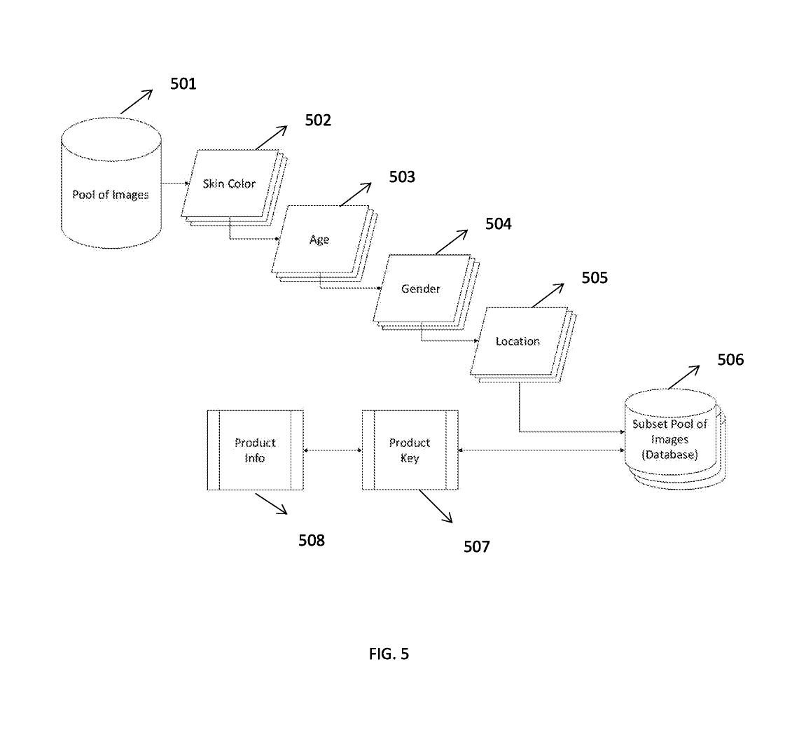

FIG. 5 depicts, in accordance with various embodiments of the present disclosure, database partitioning in the memory of the images and the factors that may be relevant to product selection and outcomes.

Although the storage of images may be partitioned in numerous different ways, FIG. 5 depicts an exemplary embodiment of a manner in which the data may be partitioned. As shown in FIG. 5, the pool of images 501 stored in the memory are partition based on skin color 502, age 503, gender 504 and location 505. All these partitions may be stored in a plurality of subsets of pool of images 506, corresponding to each partition.

The subset pool of images 506 are further stored in co-relation with the product key 507 and product info 508. It should be noted that the above described database partition is merely exemplary and numerous other parameters may be used to partition the pool of images into the subsets of pools of images.

Once the ranking is performed on the products/services and presented to the customer, the server may make a copy of the latest rankings of the products/services and store it on the customer device so as to provide faster lookup for future reference for the customer. Such a technique may provide for lesser internet usage by preventing the need for extracting the same rankings from the database again and again and may further reduce load on the processors running the servers and the customer device.

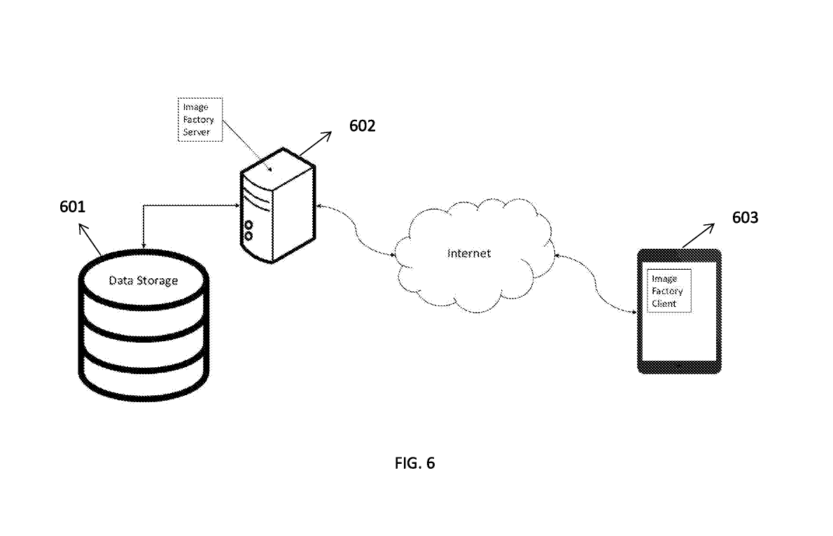

FIG. 6 depicts, in accordance with various embodiments of the present disclosure, a block diagram of an image factory server communicating with an image factory client on a user device and a storage.

As shown in FIG. 6 the image factory server 602 communicates with the data storage 601 to store the metrics extracted from the images/videos and to further store the pool of images/videos themselves. The image factory server may further communicate, via the Internet 603, with the devices 604 (mobile devices and/or computers) used by customers and/or vendors to upload information, products, images/videos etc.

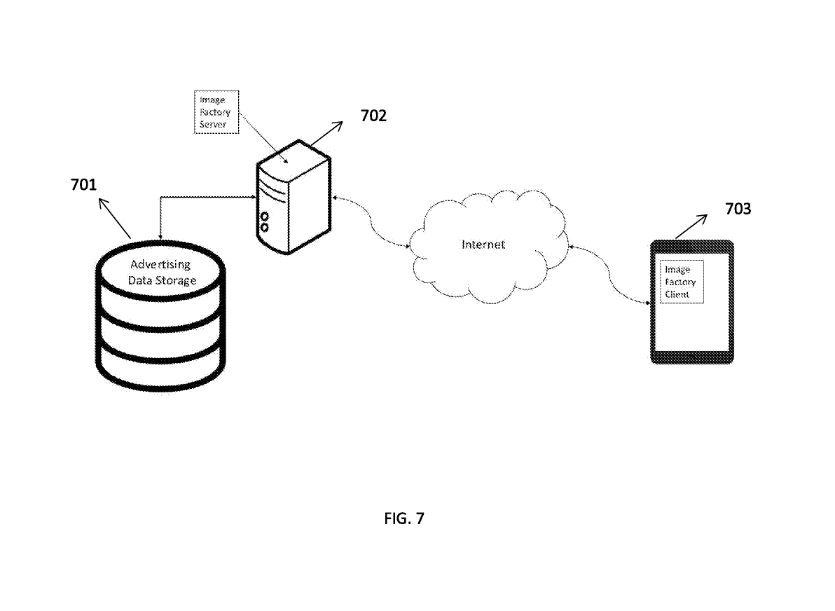

FIG. 7 depicts, in accordance with various embodiments of the present disclosure, a block diagram of an image factory server communicating with an image factory client on a user device and an advertising storage, according to an exemplary embodiment.

As shown in FIG. 7, the image factory server 702 communicates with the advertising data storage 701 to obtain advertising information to be displayed on the devices 604 (mobile devices and/or computers) used by customers and/or vendors. The image factory server may further communicate, via the Internet 703, with the devices 704 (mobile devices and/or computers) used by customers and/or vendors to upload information, products, images/videos etc.

The image factory server 702 may use the obtained advertising information and communicate it to the devices 704. The advertising information may be chosen based on several parameters such as the kind of treatment being searched for by the customer, the age group of the customer, the location etc., but is not limited thereto.

### EXAMPLES

The following examples are provided to better illustrate the claimed invention and are not intended to be interpreted as limiting the scope of the invention. To the extent that specific materials or steps are mentioned, it is merely for purposes of illustration and is not intended to limit the invention. One skilled in the art may develop equivalent means or reactants without the exercise of inventive capacity and without departing from the scope of the invention.

According to an exemplary embodiment, a user, using a mobile device and an application running on the mobile device, may upload images/videos to the servers using guidance provided by the application. The application may further guide the user to center the region of the body for which treatment is needed and place the region within a shape denoted by a dotted line—for instance a circle, square, or other shape. In other examples, the device may give the user instructions for distance away from the malady the user must capture a photo from.

The application may further provide the user different options to mark the images or videos after uploading them. For instance, the application may request that the user upload the images, and then highlight the area of the malady of interest. In this example, a border recognition algorithm may not be necessary. In other examples a border detection algorithm may refine the area selected by the user. As mentioned above, the application may request the user specify the type of malady the user believes the malady is.

The application may further pre-process the captured raw still image/video and then send it to the server. Pre-processing may include, but is not limited to, simple image processing techniques to minimize the data to be sent over the data communication networks and to improve image quality and region detection. Additionally, a user mobile device may automatically tag the location to the data or other computing device.

Customer profile data such as age, ethnicity and skin color along with the metric sent with customer's image/video will be used to select a sub-dataset which has been indexed within a database of images/videos accessible to the server. A skin color detection algorithm might be used to narrow down the sub-dataset to be used, according to an exemplary embodiment. The subset data is extracted from a set of indexed pool of images/videos collected for each product and placed in the database. Authorized images/videos collected from sellers/vendors and images/videos collect from customers may be indexed to accelerate dataset segmentation.

Customer data (e.g. the before images) may then be fed through a pre-trained deep neural network, according to an exemplary embodiment, to extract features and then may further be fed through a classifier, such as a multi-class support vector machine, to be classified as an acne problem, wart problem, or other skin malady. This process may be weighted by a customer's indication of their belief of the classification of the malady.

Each product that has been identified within a database as an acne treatment may have a pre-calculated score. Scores can be weighted based on metrics that include: number of before/after images, time elapsed between images/video samples, customer review, and customer purchasing authentication, but the metrics are not limited thereto and may include more or less than the metrics listed above.

An image/video depicting the treatment area before and after the treatment, uploaded by a seller/vendor, may be processed using a feature extraction algorithm that is a trained deep convolution neural network, according to an exemplary embodiment, to extract features of interest from a selected neural network layer. Feature extracted from the neural network layer might include blob detection, boundary detection, and other features that may have been learnt by the neural networks and marked as a usable feature during the training process of the deep neural network.

Before and after features might be processed separately but indexed in ways to make them related to one another. Differences to be measured might be based on the size of the region and the color difference between the pre-determined skin color of the customer.

Customer uploaded data may be further processed using the feature extraction process to rank products based on similarities\agreements in the feature being extracted with respect to the extracted features from the before images. Product ranking and/or recommendation will then be sent to the user based on the pre-calculated score as discussed above.

### Computer and Hardware Implementations

It should initially be understood that the disclosure herein may be implemented with any type of hardware and/or software, and may be a pre-programmed general purpose computing device. For example, the system may be implemented using a server, a personal computer, a portable computer, a thin client, or any suitable device or devices. The disclosure and/or components thereof may be a single device at a single location, or multiple devices at a single, or multiple, locations that are connected together using any appropriate communication protocols over any communication medium such as electric cable, fiber optic cable, or in a wireless manner.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a data communication network. Examples of data communication networks include a local area network (“LAN”) and a wide area network (“WAN”), an inter-network (e.g., the Internet), Wi-Fi, and peer-to-peer networks (e.g., ad hoc peer-to-peer networks).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a “data processing apparatus” on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Navigation Satellite System (e.g. GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

### CONCLUSION

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Certain embodiments of this application are described herein. Variations on those embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

Particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

What is claimed is:

1) A system for providing a personalized recommendation of products/services to a user, the system comprising:
at least one user communication device;
at least one seller communication device;
at least one server configured to communicate with the at least one user communication device and the at least one seller communication device;
a memory containing machine readable medium comprising machine executable code having stored thereon instructions for tracking the movements of the at least one object; and
a control system comprising at least one processor coupled to the memory, the control system configured to execute the machine executable code to cause the control system to:
receive, at a server, at least one image or at least one video pertaining to a product or service from a seller;
extract, by the server, metrics from the at least one image or the at least one video received from the seller;
receive, by the server at least one image or at least one video from the user;
extract, by the server, metrics from the at least one image or the at least one video received from the user;
match, by the server, the features extracted from the at least one image or the at least one video received from the seller with the features extracted from the at least one image or the at least one video;
rank, by the server, the product/service based on the match results; and
provide recommendation to the user based on the rank.

2) The system of claim 1, wherein the control system is further configured to execute the machine executable code to cause the control system to process, by the server, the at least one image or the at least one video from the user using a pre-trained deep neural network.

3) The system of claim 1, wherein the control system is further configured to execute the machine executable code to cause the control system to receive, at the server, information regarding a location of the user along with the at least one image or the at least one video.

4) The system of claim 3, wherein the control system is further configured to execute the machine executable code to cause the control system to rank, by the server, the products or services based on the received information regarding location of the user.

5) The system of claim 1, wherein the control system is further configured to execute the machine executable code to cause the control system to receive, at the server at least one of profile information, time of day, age, skin color and gender from the user along with the at least one image or the at least one video.

6) The system of claim 5, wherein the control system is further configured to execute the machine executable code to cause the control system to rank, by the server, the products or services based on the received at least one of profile information, time of day, age, skin color, condition state and details/dimensions, and gender.

7) The system of claim 1, wherein the control system is further configured to execute the machine executable code to cause the control system to:
store the at least one image or the at least one video pertaining to the product/service received from a seller in a database; and
store the at least one image or the at least one video received from the user in the database.

8) The system of claim 7, wherein the control system is further configured to execute the machine executable code to cause the control system to partition the database based on one of gender, skin color, age and location.

9) A method for providing a personalized recommendation of products/services to a user, the method comprising:
receiving, using at least one of said at least one processor, at least one image or at least one video pertaining to a product/service from a seller;
extracting, using at least one of said at least one processor, features from the at least one image or the at least one video received from the seller;
receiving, using at least one of said at least one processor, at least one image or at least one video from the user;
extracting, using at least one of said at least one processor, features from the at least one image or the at least one video received from the user;
matching, using at least one of said at least one processor, the features extracted from the at least one image or the at least one video received from the seller with the metrics extracted from the at least one image or the at least one video;
ranking, using at least one of said at least one processor, the product/service based on the match results; and
providing, using at least one of said at least one processor, recommendation to the user based on the rank.

10) The method of claim 9, wherein the receiving the at least one image or the at least one video from the user further comprises processing the at least one image or the at least one video from the user through a pre-trained deep neural network.

11) The method of claim 9 further comprising receiving, using at least one of said at least one processor, information regarding location of the user along with the at least one image or the at least one video.

12) The method of claim 11 further comprising ranking, using at least one of said at least one processor, the product/service based on the received information regarding relative location information of the user.

13) The method of claim 9 further comprising receiving, using at least one of said at least one processor, at least one of profile information, time of day, age, skin color, ethnicity, condition state, health condition, and gender from the user along with the at least one image or the at least one video.

14) The method of claim 13 further comprising ranking, using at least one of said at least one processor, the product/service based on the received at least one of profile information, time of day, age, skin color and gender.

15) The method of claim 9, further comprising:
storing, using at least one of said at least one processor, the at least one image or the at least one video pertaining to the product/service received from a seller in a database; and
storing, using at least one of said at least one processor, the at least one image or the at least one video received from the user in the database.

16) The method of claim 15, further comprising partitioning the database, using at least one of said at least one processor, based on one of gender, skin color, age and location.

17) A system for providing a personalized recommendation of products/services to a user, the system comprising:
at least one server configured to communicate with at least one user communication device and at least using one seller communication device;
a memory containing machine readable medium comprising machine executable code having stored thereon instructions for tracking the movements of the at least one object;
a control system comprising at least one processor coupled to the memory, the control system configured to execute the machine executable code to cause the control system to:
receive at least one image or at least one video pertaining to a product or service from a seller;
store the at least one image or the at least one video pertaining to a product or service received from the seller in a database stored in the memory;
extract metrics from the at least one image or the at least one video received from the seller using machine learning;
receive at least one image or at least one video from the user;
store the at least one image or the at least one video received from the user in the database stored in the memory;
extract metrics from the at least one image or the at least one video received from the user using a pre-trained machine learning;
classify the at least one image or at least one video received from the user using a classifier as including a category of skin malady;
match the metrics extracted from the at least one image or the at least one video received from the seller with the metrics extracted from the at least one image or the at least one video based on the category of skin malady;
rank the product/service based on the match results; and
provide recommendation to the user based on the rank.

18) A method for providing a personalized recommendation of products/services to a user, the method comprising:
receiving, using at least one of said at least one processor, at least one image or at least one video pertaining to a product or service from a seller;
storing, using at least one of said at least one processor, the at least one image or the at least one video pertaining to a product or service received from the seller in a database;
extracting, using at least one of said at least one processor, metrics from the at least one image or the at least one video received from the seller using a machine learning algorithm;
receiving, using at least one of said at least one processor, at least one image or at least one video from the user;
storing, using at least one of said at least one processor, the at least one image or the at least one video received from the user in the database;
extracting, using at least one of said at least one processor, metrics from the at least one image or the at least one video received from the user using the machine learning algorithm;
matching, using at least one of said at least one processor, the metrics extracted from the at least one image or the at least one video received from the seller with the metrics extracted from the at least one image or the at least one video;
ranking, using at least one of said at least one processor, the product or service based on the match results; and
providing, using at least one of said at least one processor, recommendation to the user based on the rank.

19) The method of claim 18, wherein one of said at least one processor classifies the at least one image or the least one video received from the user as a category of skin malady or laundry stain using the extracted metrics.

20) The method of claim 18, wherein one of said at least one processor selects advertising to display to the user based on the metrics extracted from the at least one image.

21) The method of claim 20), wherein the product is a detergent.

22) The method of claim 20), wherein the product is a wearable product (e.g. sunglass).
